(19) United States
(12) Patent Application Publication
(10) Pub. No.: US 2007/0189535 A1
(43) Pub. Date: Aug. 16, 2007

(54) Method and apparatus for protecting contents supporting broadcast service between service provider and a plurality of mobile stations

(75) Inventors: Byung-Rae Lee, Yongin-si (KR); Joon-Goo Park, Yongin-si (KR); Bo-Sun Jung, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/320,332

(22) Filed: Dec. 29, 2005

(30) Foreign Application Priority Data
Apr. 4, 2005 (KR) 2005-28305

(51) Int. Cl. G06F 12/14; H04K 1/00; H04L 9/00; H04L 9/32; G06F 11/30

(52) U.S. Cl. 380/255; 380/281; 380/270; 713/189; 380/273

(57) ABSTRACT

A method of receiving by a mobile station an encrypted form of broadcast service content broadcasted by a service provider (SP). The method includes receiving at least one encryption key from the SP, receiving a broadcast control message comprising a second encryption key, and decrypting the broadcast control message with the at least one encryption key to obtain the second encryption key. The method further includes receiving the encrypted form of the broadcast service content and decrypting the encrypted broadcast service content by a process involving use of the second encryption key.

### PRIORITY

This application claims priority under 35 U.S.C. § 119 to an application entitled “Method and Apparatus for Protecting Contents Supporting Broadcast Service between Service Provider and a Plurality of Mobile Stations” filed in the Korean Intellectual Property Office on Apr. 4, 2005 and assigned Serial No. 2005-28305, the contents of which are incorporated herein by reference.

### BACKGROUND OF THE INVENTION

1. Field of the Invention

The present invention relates generally to a method and apparatus for protecting contents supporting a broadcast service between a service provider and a plurality of mobile stations.

2. Description of the Related Art

Popularization of mobile stations due to development of an information and communication field has allowed mobile station subscribers to use various convenient features, such as a data service and an Internet service, besides a typical call function. Along with the strengthening of the multimedia functions in mobile stations as well as the development of such convenient features, the mobile stations are configured so that a number of multimedia application programs are embedded. For example, various contents, such as text information, images, audio, and video, which have been accessed through offline media, can be used in mobile stations.

Such a content service is expected to gradually change to a paid service. Service providers providing such a content service may provide its subscribers with a content service based on the copy prevention technology. For example, a system configuration for performing a conventional broadcast service is illustrated in FIG. 1. Referring to FIG. 1, a service provider (SP) 10 provides a service encryption key (SEK) required to execute a service to each of mobile stations (MSs) 40, 50, and 60 using the broadcast service in step 20. Each of the MSs 40, 50, and 60 executes an encrypted service transmitted from the SP 10 by decoding the encrypted service using the provided SEK.

Recently, the digital rights management (DRM) based on flexibility and serviceability of a Right Object (RO) of contents has been introduced. According to the DRM technology, while encrypted contents may be freely distributed among users, it may be required that the RO be purchased to execute a desired content. The DRM is one of representative security schemes for protecting contents and defines encrypted contents and a usage right of the contents. While the DRM system is discussed in detail along with its problems, similar problems may also arise in other broadcast service content protection systems.

This configuration is illustrated in FIG. 2. FIG. 2 is an illustration of a conventional DRM content distribution process. Referring to FIG. 2, the MS 40 forms a secure channel through a security association (SA) with the SP 10 to receive and execute an encrypted content provided by the SP 10 in step 70. The SP 10 generates and issues the RO, which is an object in which a usage right of a content is defined. The MS 40 can receive the RO via a secure channel formed in step 80 and allows a user to enjoy multimedia information included in the content by decrypting the DRM-encrypted content using the RO.

However, current content protection technology schemes achieve their purpose through a SA between an SP and one MS. Further, there is no detailed plans as to how to actually protect contents for a plurality of MSs using the broadcast service in a mobile communication environment.

Although the DRM system is discussed above in detail along with its problems, the foregoing deficiencies may also arise in other broadcast service content protection systems.

### SUMMARY OF THE INVENTION

Accordingly, the present invention provides a method of protecting contents supporting a broadcast service between a service provider and a plurality of mobile stations in a mobile communication environment.

The present invention also provides a method of receiving by a mobile station an encrypted form of broadcast service content broadcasted by a service provider (SP). The method includes receiving at least one encryption key from the SP, receiving a broadcast control message comprising a second encryption key, and decrypting the broadcast control message with the at least one encryption key to obtain the second encryption key. The method further includes receiving the encrypted form of the broadcast service content and decrypting the encrypted broadcast service content by a process involving use of the second encryption key.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic configuration of a system for performing a conventional broadcast service;

FIG. 2 is an illustration of a conventional DRM content distribution process;

FIG. 3 is a block diagram of a content protection system according to a preferred embodiment of the present invention;

FIG. 4 is a signaling diagram for illustrating a service joining method according to a preferred embodiment of the present invention;

FIG. 5 is a structural diagram of a broadcast service control message format according to a preferred embodiment of the present invention;

FIG. 6 is a signaling diagram for illustrating a method of selecting and joining a broadcast service according to another preferred embodiment of the present invention;

FIG. 7 is a signaling diagram for illustrating a broadcast service content transmission process according to a preferred embodiment of the present invention;

FIG. 8A is a structural diagram of broadcast content message format encrypted with SEK according to a preferred embodiment of the present invention;

FIG. 8B is a structural diagram of broadcast service control message format encrypted with SEK according to a preferred: embodiment of the present invention;

FIG. 8C is a structural diagram of broadcast content message format encrypted with TEK according to a preferred embodiment of the present invention;

FIG. 9 is a signaling diagram for illustrating a service revocation process to receive a new SEK according to a preferred embodiment of the present invention;

FIG. 10 is a structural diagram of a revocation message format according to a preferred embodiment of the present invention;

FIG. 11 is a signaling diagram for illustrating a service withdrawal process according to a preferred embodiment of the present invention; and

FIGS. 12A and 12B are structural diagrams of message formats for performing a service withdrawal according to a preferred embodiment of the present invention.

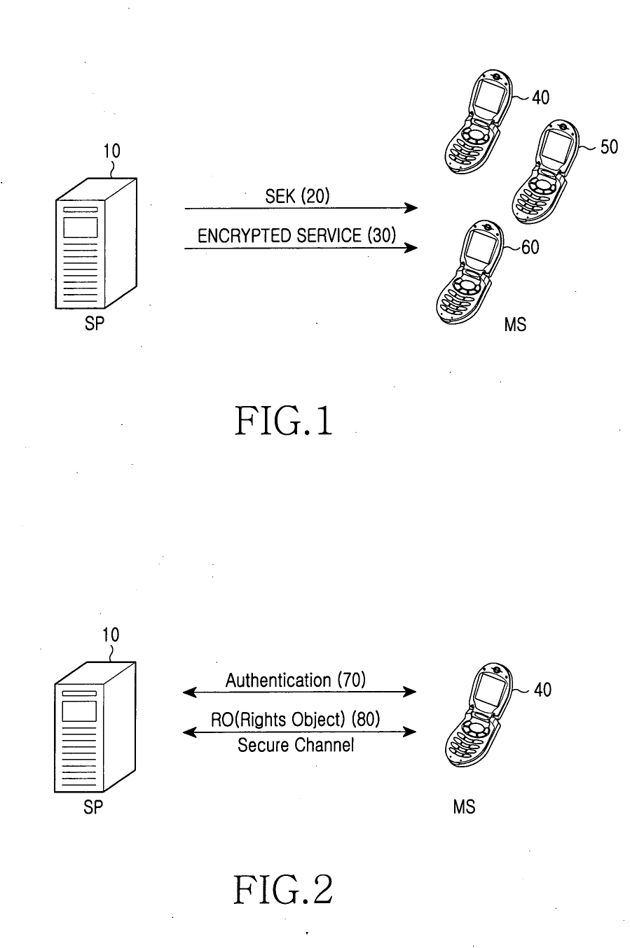

### DETAILED DESCRIPTION OF THE PREFERRED EMBODIMENT

An exemplary embodiment of the present invention will now be described in detail with reference to the annexed drawings. In the drawings, the same or similar elements are denoted by the same reference numerals even though they may depicted in different drawings. In the following description, a detailed description of known functions and configurations incorporated herein has been omitted for clarity and conciseness.

In the present invention, a function of protecting contents supporting a broadcast service in a mobile communication environment is implemented. According to an exemplary embodiment, the present invention is configured to provide a method of protecting contents broadcasted between a service provider and a plurality of mobile stations using DRM. Although the protection system is illustrated with a system using the DRM, the present invention may also be applied to other protection systems for communicating broadcast service contents to mobile stations. According to an exemplary embodiment of the present invention, a service provider may provide a broadcast service content and its service right object (RO) by encrypting them in the broadcast service, wherein a mobile station, which has received the encrypted content, requires the RO to realize the broadcast service.

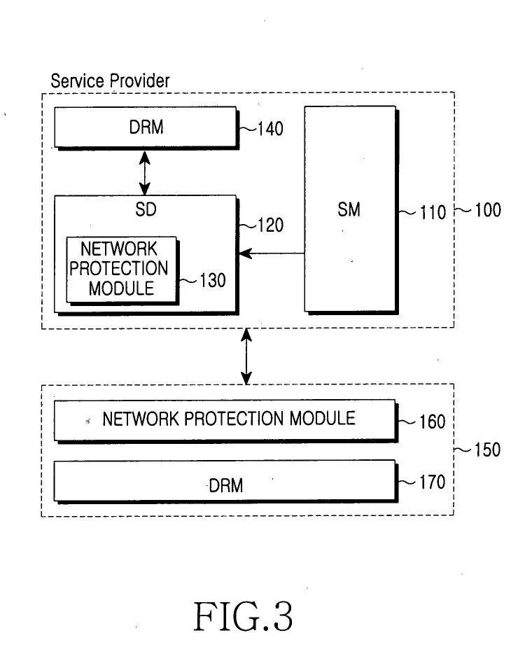

Exemplary elements of an exemplary system applying the DRM to the broadcast service will now be described with reference to FIG. 3 that shows a block diagram of a content protect system according to a preferred embodiment of the present invention.

Referring to FIG. 3, a service provider (SP) 100 according to an exemplary embodiment of the present invention performs the broadcast service, generates and issues a service RO, and provides the RO to mobile stations (MSs) authorized to use contents. The service RO may include an encryption key. The service RO may further include information related to access rights of the receiving mobile station with respect to broadcast service contents including but without limitation the duration and frequency of the allowed access. A mobile station as referred to throughout the disclosure can be any device for conducting wireless communication including but not limited to cell phones, PDA and computers. A service provider as referred to throughout the disclosure can be any device for conducting wireless broadcast including but not limited to broadcast content providers and operators of infrastructure systems for transmitting the broadcast content. The SP 100 according to an exemplary embodiment of the present invention may include a means for receiving (e.g., an antenna) messages related to broadcast services (e.g., broadcast service control messages such as a service request message) from mobile terminals and a means for transmitting (e.g., an antenna) messages (e.g., broadcast service contents and service control messages such as encryption keys) related to broadcast services and may include modules described below. A subscription management (SM) module 110 according to an exemplary embodiment of the present invention manages subscribers of the broadcast service. A service distribution (SD) module 120 may provide a function of encrypting broadcast data, distributing the broadcast service, and protecting the service. A network protection module 130, according to an exemplary embodiment of the present invention, which guarantees security of a network layer, may receive a content of the broadcast service and process the content in a type suitable for a broadcast network. In detail, the network protection module 130 supports Internet protocol (IP) security and a secure real time transmission protocol (SRTP). A DRM module 140 according to an exemplary embodiment of the present invention receives the service RO generated by the SD module 120 and encrypts the service RO.

An MS 150 receives the broadcast service from the SP 100 and executes contents. The MS 150 according to an exemplary embodiment of the present invention may include a means for transmitting (e.g., an antenna) messages related to broadcast services (e.g., broadcast service control messages such as a service request message) and a means for receiving (e.g., an antenna) messages (e.g., broadcast service contents and service control messages such as encryption keys) related to broadcast services and may include a network protection module 160 and a DRM agent 170. Like the network protection module 130 of the SP 100 described above, the network protection module 160 processes the IP security and the SRTP. The DRM agent 170 manages decryption of the service RO and usage rule observance.

For the MS 150 to receive contents using the broadcast service according to a preferred embodiment of the present invention, the MS 150 should join the broadcast service. The MS 150 joined in the service can execute contents by receiving the service RO from the SP 100.

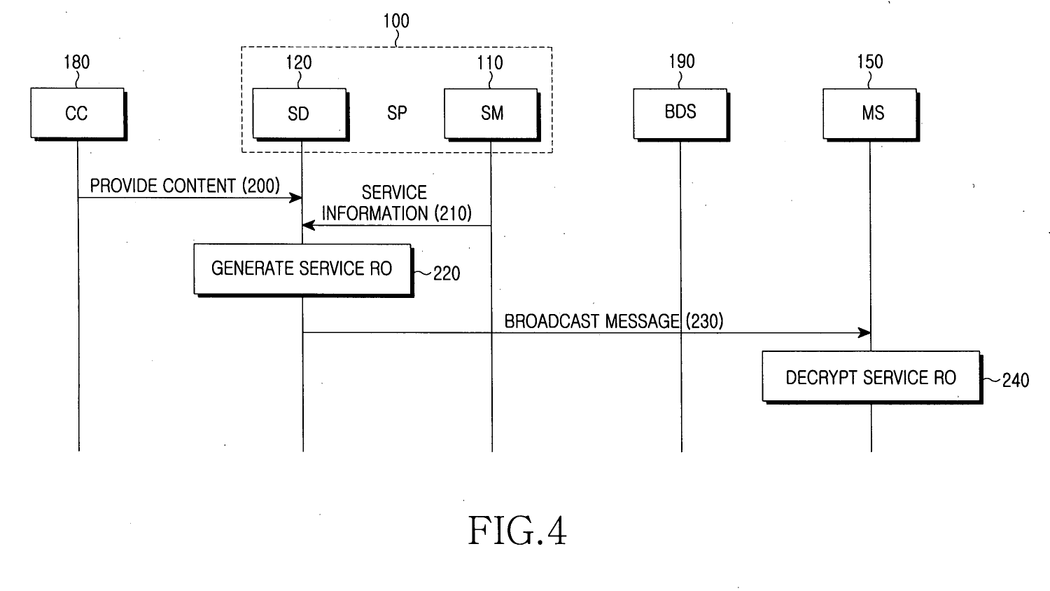

A process for an MS to join the broadcast service to protect contents supporting the broadcast service will now be described with reference to FIG. 4 that shows a signaling diagram for illustrating a service joining method according to a preferred embodiment of the present invention.

Prior to description of FIG. 4, each functional entity of the broadcast service for protecting contents according to an exemplary embodiment of the present invention will now be described.

Detailed configurations of the SP100 and the MS 150 may be equal to the description of FIG. 3, and the remaining entities, a content creator (CC) 180 and a broadcast distribution system (BDS) 190 according to an exemplary embodiment of the present invention, will now be described.

The BDS 190 according to an exemplary embodiment of the present invention is a network carrying the broadcast service and provides the broadcast service to lower networks. Examples of the BDS 190 are Digital Video Broadcasting-Handheld (DBV-H), Multimedia Broadcast/Multicast Service (MBMS) of 3.sup.rd Generation Project Partnership (3GPP), and Broadcast/Multicast Service (BCMCS). The CC 180 is a content generation organization and actually provides contents. The MS 150 can execute contents by receiving the broadcast service through the functional entities.

Hereinafter, it is assumed that a security association (SA) to share encryption keys common between the SP 100 and the MS 150 is achieved in a state where the MS 150 is enrolled in the SP 100 according to a preferred embodiment of the present invention. The SP 100 and the MS 150 can obtain a broadcast encryption key (BEK) and a broadcast authentication key (BAK), which are common keys to each other, through the SA. The BEK may be used to encrypt data in the broadcast service, and the BAK may be used by, for example, SP and/or MS to calculate a Message Authentication Code (MAC) for verifying by, for example, the SP and/or MS, whether the MS 150 is an MS which can join the service.

Referring to FIG. 4, while performing the SA, the SD 120 of the SP 100 according to an exemplary embodiment of the present invention may receive a broadcast service content from the CC 180 in step 200, receive service information related to a subscriber from the SM 110 in step 210, and then generate a service RO in step 220. The DRM module 140 may receive the generated service RO from the SD and encrypt the service RO using the BEK. pre-provided through the SA, and then in step 230, the SD 120 broadcast a broadcast service control message containing the service RO encrypted by the DRM module 140 to a plurality of MSs including the MS 150. Herein, the RO of each service is periodically transmitted to the plurality of MSs, this activity is called re-keying, and a re-keying message format is equal to a broadcast message format. Further, a new RO to replace the information in the previously transmitted RO may also be transmitted in case the protection of the system is compromised (e.g., hacking).

In broadcast environment of FIG. 4, the joining of the broadcast service may be achieved by a process including obtaining common keys as like the BEK and BAK with the SP 100 through the SA without the MS 150 directly transmitting a request to join the service.

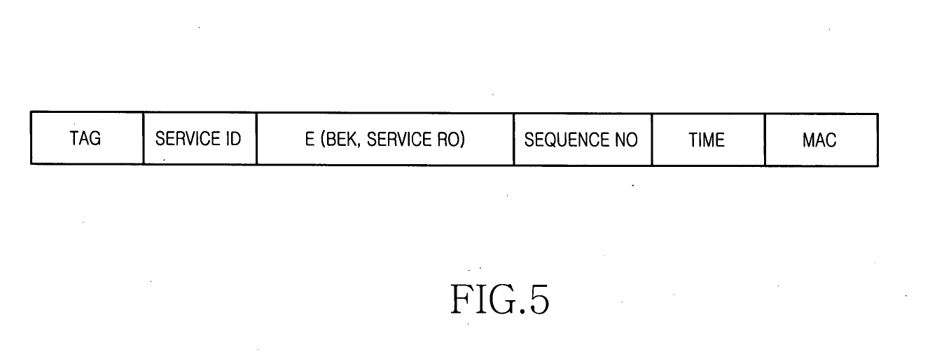

The format of an exemplary broadcast control message broadcasted from the SP 100 to the MS 150 is illustrated in FIG. 5. Referring to FIG. 5, the broadcast control message format according to an exemplary embodiment of the present invention may be configured by largely including tag, service ID, encrypted information, sequence number, time, and MAC fields. Information for indicating a broadcast message transmitted from the SP 100 is set in the tag field which is a field indicating a kind of the message, a service name that the MS 150 wants/is to join, e.g., service identification information, is set in the service ID field, and a current time is set in the time field. In the encrypted information field, information obtained by encrypting the service RO using the BEK (RO may include an encryption key of the MS 150 and may further include information related to access rights of the receiving mobile station with respect to broadcast service contents including but without limitation the duration and frequency of the allowed access) is included. This can be schematically represented by E(K, D), which means an operation of encrypting data D using an encryption key K. Thus, the information obtained by encrypting the service RO using the BEK which is an encryption key of the MS 150 can be represented by E(BEK, Service RO). Herein, the symbol E denotes encryption.

In the MAC field according to an exemplary embodiment of the present invention, information to protect the message through the MAC operation using the encryption keys shared with the SP 100 is set. In another embodiment, information, such as an electronic signature by which the SP 100 can know that the message is transmitted from a specific subscriber by signing, by an MS, with its own secret key, is set.

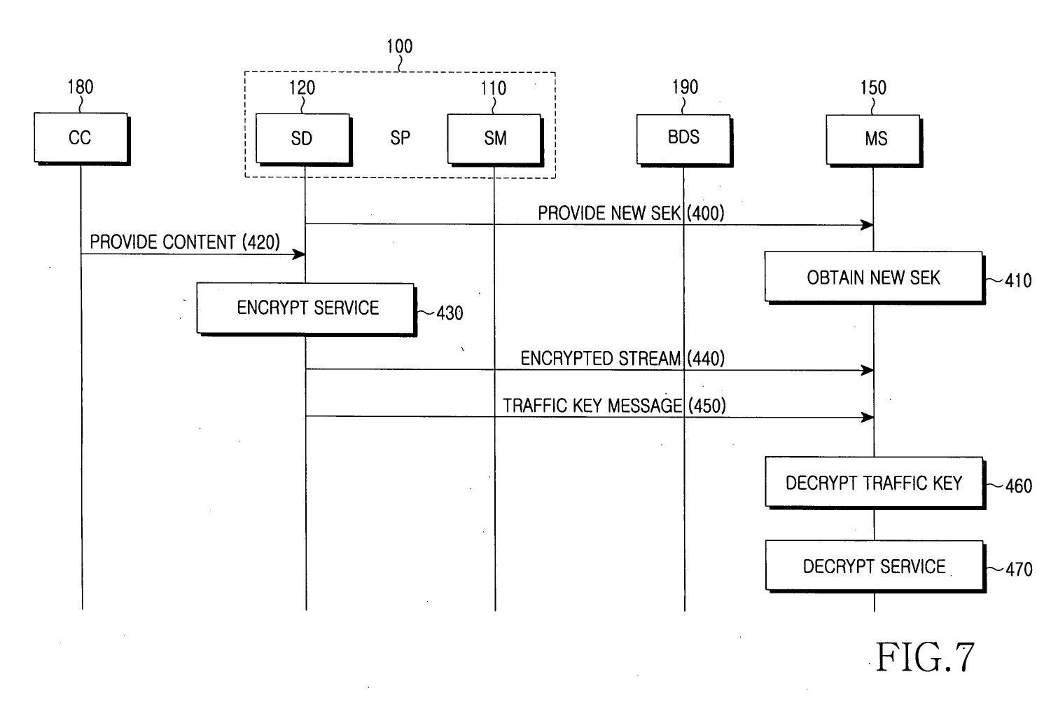

If the MS 150 receives the broadcast control message containing the service RO from a means for receiving (e.g., an antenna, which may be any conventionally well known signal receivers and are not illustrated any further as such) messages related to broadcast services, according to an exemplary embodiment of the present invention, the MS 150 verifies the broadcast message. This verification is a process of determining whether the message broadcasted from the SP 100 is a message transmitted to the MS 150. For example, the MS 150 can perform the verification by using the information set in the MAC field. However, even if the verification succeeds, if according to the time in the time field of the message format there is delay greater. than a pre-set value, the broadcast control message is ignored. If both the MAC field verification and the time field confirmation succeed, the MS 150 may transmit the broadcast message to the internal DRM agent 170, and in step 240, the DRM agent 170 may obtain a service encryption key (SEK) in the service RO by decrypting the service RO contained the received broadcast message using the BEK already obtained. The MS 150 uses the SEK to decrypt the encrypted content. In an alternative embodiment, the SEK may be an encryption key for encrypting another encryption key (e.g., TEK (Traffic Encryption Key)), in which case, the MS receives another broadcast control message comprising the another encryption key, uses the first received encryption key (e.g., SEK) to decrypt the another broadcast control message to obtain the another encryption key, and use the another encryption key (e.g., TEK) to decrypt the broadcast service content, which has been encrypted with the TEK. Such use of the another encryption key may provide many benefits including added protection. Thus, according to an exemplary embodiment of the present invention, the broadcast service content is able to be encrypted by either the SEK or the TEK, wherein the TEK is encrypted by the SEK and the Service RO including SEK is able to be encrypted by the BEK. A decryption (i.e., including each and every decryption using the Public Codes, BEK, SEK, or TEK) by a mobile station of broadcast service contents and/or broadcast control messages as referred to throughout the disclosure may be accomplished in any single one of the Network Protection Module 160 and DRM Agent 170 or both and each individual one of 160 and 170 or both may form a means for performing such functions. Herein, decrypting procedure for the broadcast service content encrypted the TEK will be described in the exemplary embodiment relating to FIG. 7.

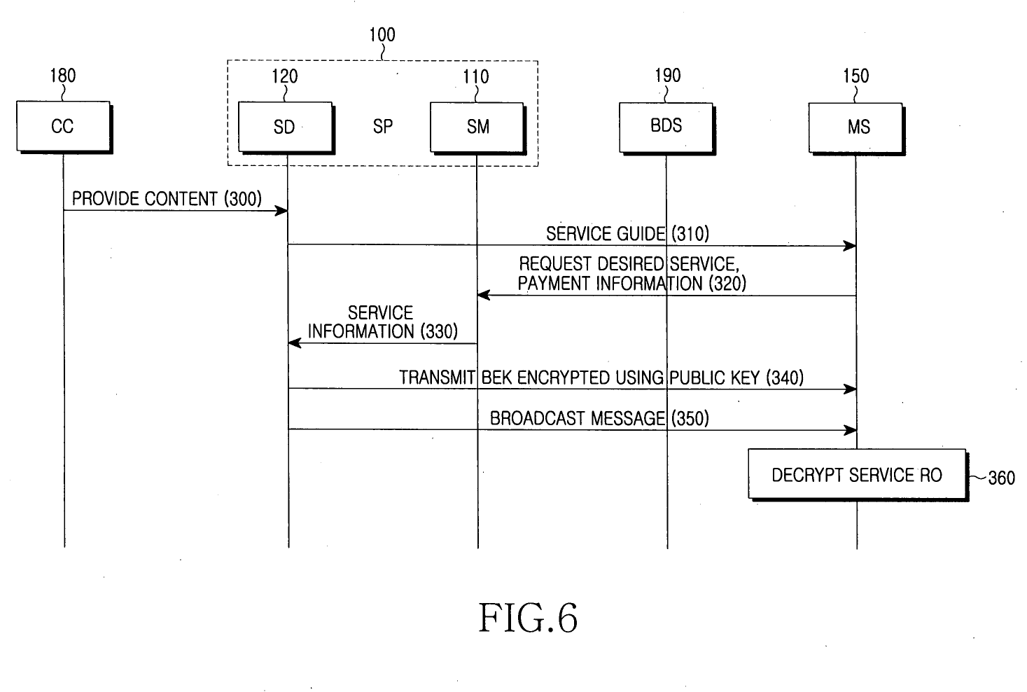

A method of joining a service selected by the user will now be described with reference to FIG. 6. However, the description of the procedures therein other than the actual selection of a broadcast service by a user is also applicable for other embodiments of the present invention where such selection is not made by a request from the user.

Referring to FIG. 6, if the SD 120 of the SP 100 according to an exemplary embodiment of the present invention is to receive a broadcast service content from the CC 180 in step 300, the SD 120 may transmit a service guide containing content information to the MS 150 in step 310. The MS 150 selects a desired service from the service guide and transmits a message, which may contain a service ID of the selected service and payment information of the selected service, to the SM 110 of the SP 100 in step 320. For a broadcast service only MS, the service ID and the payment information can be transmitted using a PC or a server, which can perform interactive communication. The SP 100 transmits the message transmitted from the MS 150 to the internal SM 110, and in step 330, the SM 110 confirms the selected service ID, transmits service information of the selected service to the SD 120, and updates its own internal information. The SD 120, which has received the service information, transmits a BEK encrypted using an MS public key to the MS 150 in step 340 and broadcasts a broadcast message containing a service RO to MSs including the MS 150 in step 350. Since a format of the broadcast message is equal to the message format of FIG. 5, detailed description of the format is omitted. An operation of the MS 150, which has received the broadcast message, performing in step 360 is also equal to the operation in step 240 of FIG. 4.

After joining the service is achieved by obtaining the service RO through the process described above, the SP 100 can transmit a broadcast service content to a certain MS, and in the present invention, the timing of when the SP 100 provides an RO of a content to the certain MS is flexible. For example, while the content is provided to the MS, the RO can be transmitted to the MS simultaneously, and on the other hand, the content can be transmitted to the MS after the RO is provided to the MS.

A process of transmitting a broadcasted service content after joining a service is actually achieved will now be described with reference to FIG. 7 that shows a signaling diagram for illustrating a service transmission process according to a preferred embodiment of the present invention.

Referring to FIG. 7, before transmitting a service, the SD 120 according to an exemplary embodiment of the present invention may transmit a new SEK to the MS 150 to protect against the possible hacking of the system with respect to the previous transmitted SEK and against any other errors after a predetermined time for a specific service key in step 400, and the MS can obtain the new SEK in step 410. Through these procedures, a service RO including the new SEK can be safely transmitted to the MS 150 by being encrypted using a BEK.

A process of achieving an actual service transmission process will now be described. The SD 120 according to an exemplary embodiment of the present invention receives a broadcast service content from the CC 180 in step 420and encrypts the content using a TEK in step 430 and broadcasts the encrypted content to the MS 150 in step 440. The SD 120 broadcasts a traffic key message (TKM) comprising the encrypted TEK to the MS 150 in step 450.

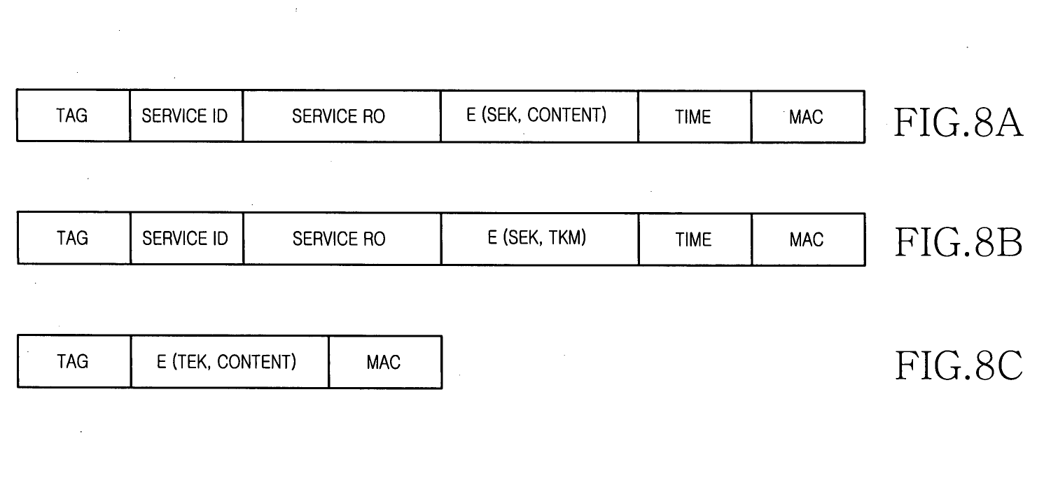

The TKM transmitted to the MS 150 according to an exemplary embodiment of the present invention can have a format illustrated in FIG. 8B. In particular, E(SEK, TEK), which is information obtained by encrypting the TEK using the SEK, is included in the format. A structure of a broadcast service message transmitted to the MS 150 is illustrated in FIG. 8C, in which E(TEK, content), which is a broadcast service content encrypted using a traffic encryption key (TEK), is included.

The MS 150 verifies integrity of the content by using a MAC value of a MAC field of the received message. If the verification succeeds, the MS 150 obtains the TEK by decrypting the encrypted TEK using the SEK in step 460. The MS 150 decrypts the encrypted broadcast service content using the TEK in step 470. As an alternative embodiment, the SP 100 can transmit a broadcast service message illustrated in FIG. 8A in which the broadcast service content to be provided is directly encrypted using the SEK to the MS 150. In such a case, the step 470 will decrypt the broadcast service content by using the SEK instead of TEK.

If the broadcast service transmission is achieved based on a network layer, the service decryption is performed as follows. The DRM agent 170 of the MS 150 transmits the obtained SEK to the network protection module 160, and the network protection module 160 decrypts the encrypted broadcast content transmitted from the SP 100 using the SEK. If the broadcast service transmission is achieved based on an application layer, the service decryption is performed by that the DRM agent 170 of the MS 150 decrypts the service transmitted in a specific DRM format using the obtained SEK. Thus, depending upon whether the broadcast service transmission is achieved based on any one of a network layer and application layer or both as describe above, a decryption (i.e., including each and every decryption using the Public Codes, BEK, SEK, and TEK) by a mobile station of broadcast service contents and/or broadcast control messages as referred to throughout the disclosure may be accomplished in any single one of the Network Protection Module 160 and DRM Agent 170 or both.

While the broadcast service transmission method has been described above, a case where a broadcast service cannot be normally transmitted may occur. For example, if a certain MS is attacked by a hacker, procedure of a service revocation (e.g., renewing the SEK) may need to be performed in order to not allow services to be executed in an inappropriate MS.

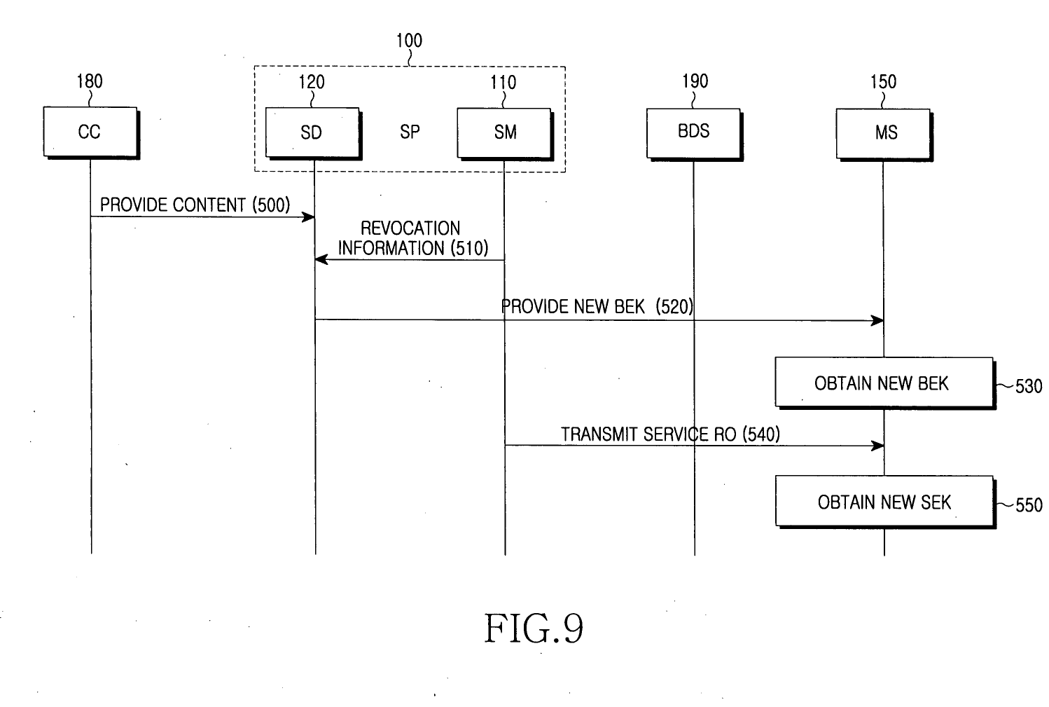

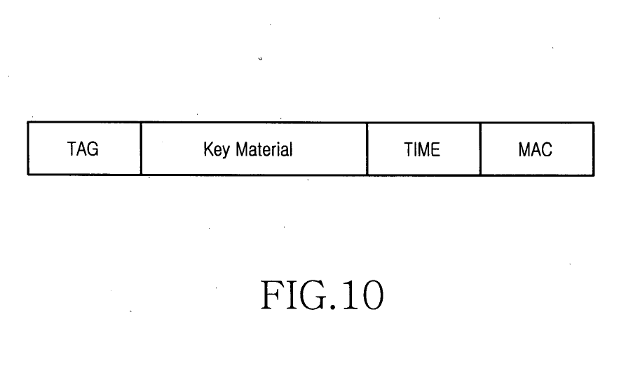

A service revocation process according to a preferred embodiment of the present invention will now be described with reference to FIG. 9. Referring to FIG. 9, the SD 120 according to an exemplary embodiment of the present invention receives a broadcast service content from the CC 180 in step 500 and receives revocation information from the SM 110 in step 510. The SD 120 transmits a revocation message containing a new BEK to the MS 150 in step 520. A format of the revocation message is illustrated in FIG. 10, and a key material field is a field in which the new BEK is set. The MS 150 obtains the new BEK by receiving the revocation message and updating its possessing BEK in step 530 but an inappropriate MS can't receive the revocation message comprising the new BEK. In step 540, the SM 110 of the SP 100 broadcasts a service RO comprising the new SEK encrypted with the new BEK to the MS 150 and a plurality of MSs. In step 550, the MS 150, which has obtained the new BEK, can obtain the new SEK by decrypting the encrypted service RO.

As described above, if the SP 100 provides a broadcast content encrypted with the new SEK to a plurality of MSs, the inappropriate MS cannot perform the decryption since it cannot obtain the new BEK.

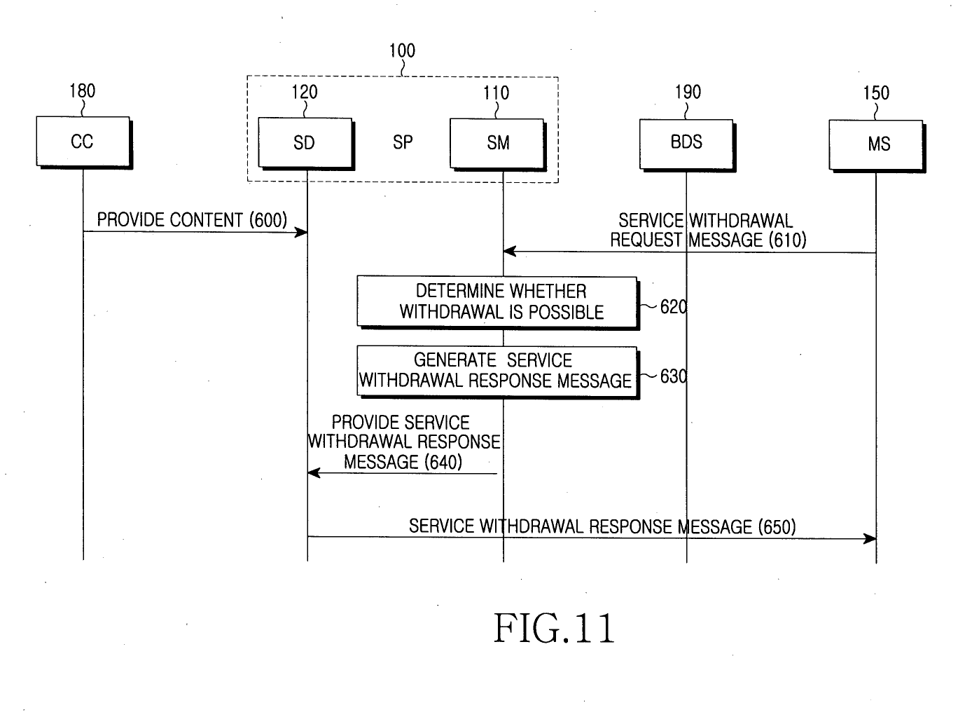

If a user of an MS joining a service does not want to use broadcast contents any more, the user can withdraw from the broadcast service to which the user currently belongs. When the MS intends to withdraw from the broadcast service, the procedures described below should be performed. To do this, a service withdrawal process according to a preferred embodiment of the present invention will now be described with reference to FIG. 11.

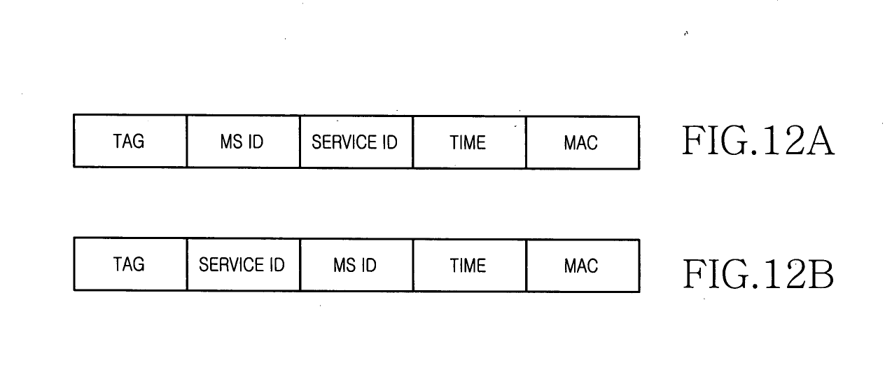

Referring to FIG. 11, while the SD 120 according to an exemplary embodiment of the present invention is receiving a content from the CC 180 in step 600, the MS 150, intending to withdraw from the service, can transmit a service withdrawal request message to the SP 100 in order to request the service withdrawal in step 610. For a broadcast service only MS, the service withdrawal request message can be transmitted using an agency such as a PC or a server that can perform interactive communication. Herein, a format of the service withdrawal request message is illustrated in FIG. 12A. In step 620, the SM 110 of the SP 100 determines whether the service withdrawal is possible through a verification process using the service withdrawal request message. If the verification succeeds, the SM 110 generates a service withdrawal response message illustrated in FIG. 12B by performing a withdrawal process in step 630 and transmits the generated service withdrawal response message to the SD 120 in step 640. In step 650, the service withdrawal response message is transmitted to the MS 150 through the SD 120.

In all the above embodiments, a broadcast service only MS can perform the processes described above by accessing the SP 100 through a device such as a PC, a PDA, or a server, which can access an interactive channel.

As described above, according to embodiments of the present invention, protection of contents through a broadcast service can be safely implemented using a structure and a message flow for the broadcast service.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method of receiving by a mobile station (MS) an encrypted form of broadcast service content broadcasted by a service provider (SP), the method comprising the steps of:
receiving at least one encryption key from the SP;
receiving a broadcast control message comprising a second encryption key;
decrypting the broadcast control message with the at least one encryption key to obtain the second encryption key;
receiving the encrypted form of the broadcast service content; and
decrypting the encrypted broadcast service content by a process involving use of the second encryption key.

2. The method of claim 1, wherein the decrypting step comprises receiving a second broadcast control message comprising a third encryption key and decrypting the encrypted service content with the third encryption key.

3. The method of claim 1, wherein the at least one encryption key comprises a broadcast encryption key and a broadcast authentication key used to verify a message communicated between the SP and the MS.

4. The method of claim 1, further comprising the step of enrolling the MS as an MS eligible to receive a broadcast service from the SP.

5. The method of claim 1, further comprising the step of receiving another encryption key to replace the at least one encryption key.

6. The method of claim 1, further comprising the step of receiving a broadcast service guide from the SP and transmitting a request for a broadcast service to the SP.

7. The method of claim 1, further comprising the step of transmitting a request to withdraw from a broadcast service to the SP.

8. A mobile station for receiving by a mobile station (MS) an encrypted form of broadcast service content broadcasted by a service provider (SP) comprising:
means for receiving at least one encryption key from the SP a broadcast control message comprising a second encryption key and the encrypted form of the broadcast service content;
means for decrypting the broadcast control message with the at least one encryption key to obtain the second encryption key and decrypting the encrypted broadcast control message by a process involving use of the second encryption key.

9. The mobile station of claim 8, wherein the receiving means is adapted for receiving a second broadcast control message comprising a third encryption key and the decrypting means is adapted for decrypting the encrypted service content with the third encryption key.

10. The mobile station of claim 8, wherein the at least one encryption key comprises a broadcast encryption key and a broadcast authentication key used to verify a message communicated between the SP and the MS.

11. The mobile station of claim 8, wherein the receiving means is adapted for receiving another encryption key to replace the at least one encryption key and decrypting means is adapted for decrypting the broadcast control message with the another encryption key to obtain the second encryption key

12. The mobile station of claim 8, wherein the receiving means is adapted for receiving a broadcast service guide from the SP to enable transmitting by the mobile station of a request for a broadcast service to the SP.

13. The mobile station of claim 8, wherein the receiving means is adapted for receiving a withdrawal response message to enable the mobile station to withdraw from a broadcast service.

14. A method of broadcasting by a service provider (SP) an encrypted form of broadcast service content to a mobile station (MS), the method comprising the steps of:
transmitting at least one encryption key from the SP;
transmitting a broadcast control message comprising a second encryption key, the second encryption key being encrypted with the at least one encryption key; and
transmitting the encrypted form of the broadcast service content, the encrypted broadcast service content being encrypted by a process involving use of the second encryption key.

15. The method of claim 14, further comprising the step of transmitting a second broadcast control message comprising a third encryption key, wherein the step of transmitting the encrypted form of the broadcast service content comprises encrypting the broadcast service content with the third encryption key.

16. The method of claim 14, wherein the at least one encryption key comprises a broadcast encryption key and a broadcast authentication key used to verify a message communicated between the SP and the MS.

17. The method of claim 14, further comprising the step of enrolling the MS as an MS eligible to receive a broadcast service from the SP.

18. The method of claim 14, further comprising the step of transmitting another encryption key to replace the at least one encryption key.

19. The method of claim 14, further comprising the step of transmitting a broadcast service guide and receiving a request for a broadcast service from a mobile station.

20. The method of claim 14, further comprising the step of receiving a request transmitted by the MS to withdraw from a broadcast service.
